(19) United States
(12) Patent Application Publication
(10) Pub. No.: US 2014/0310954 A1
(43) Pub. Date: Oct. 23, 2014

(54) WRENCH FOR MEMORY CARD

(71) Applicants: Hon Hai Precision Industry Co., Ltd., New Taipei (TW); Hong Fu Jin Precision Industry (ShenZhen) Co., Ltd., Shenzhen (CN)

(72) Inventors: MEI HUANG, Shenzhen (CN); JIAN-SHE SHEN, Shenzhen (CN); JIAN LUO, Shenzhen (CN); HONG-LIAN HUANG, Shenzhen (CN)

(73) Assignees: Hon Hai Precision Industry Co., Ltd., New Taipei (TW); Hong Fu Jin Precision Industry (ShenZhen) Co., Ltd., Shenzhen (CN)

(21) Appl. No.: 14/029,744

(22) Filed: Sep. 17, 2013

(30) Foreign Application Priority Data
Apr. 23, 2013 (CN) 2013101426030

(51) Int. Cl. H01R 43/26

(52) U.S. Cl. CPC H01R 43/26
USPC 29/764

(57) ABSTRACT

A wrench for disengaging hooks of a number of memory slots from a number of memory cards includes a main body, a handle extending from a first end of the main body, and an arced abutting portion formed on a second end of the main body opposite to the first end. When disengaging the hooks, the abutting portion are inserted between the hooks pivotably connected to same ends of the plurality of memory slots and the ends of the memory cards and pried, to make the hooks rotate away from the memory cards.

### BACKGROUND

1. Technical Field

The present disclosure relates to a wrench for memory cards.

2. Description of Related Art

In a computer, a plurality of memory cards is connected to a plurality of memory slots of a motherboard. Two hooks are formed on opposite ends of each memory slot to engage with the corresponding memory card. An operator needs to operate the hooks to pull out the memory card. Fingers of the operator may be hurt by the hooks.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a wrench together with a circuit board.

FIG. 2 is a side plan view of the wrench and the circuit board of FIG. 1, where the wrench is in a state of use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

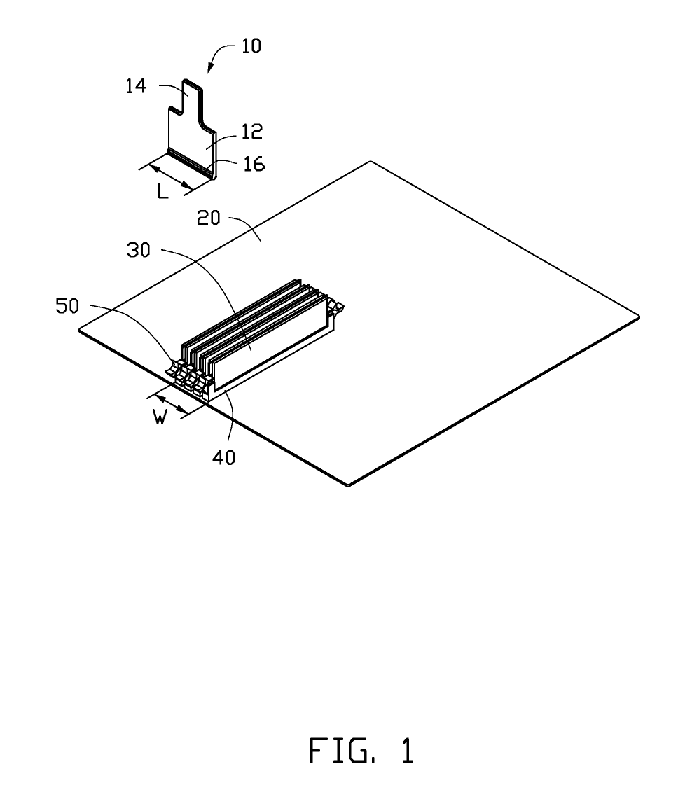

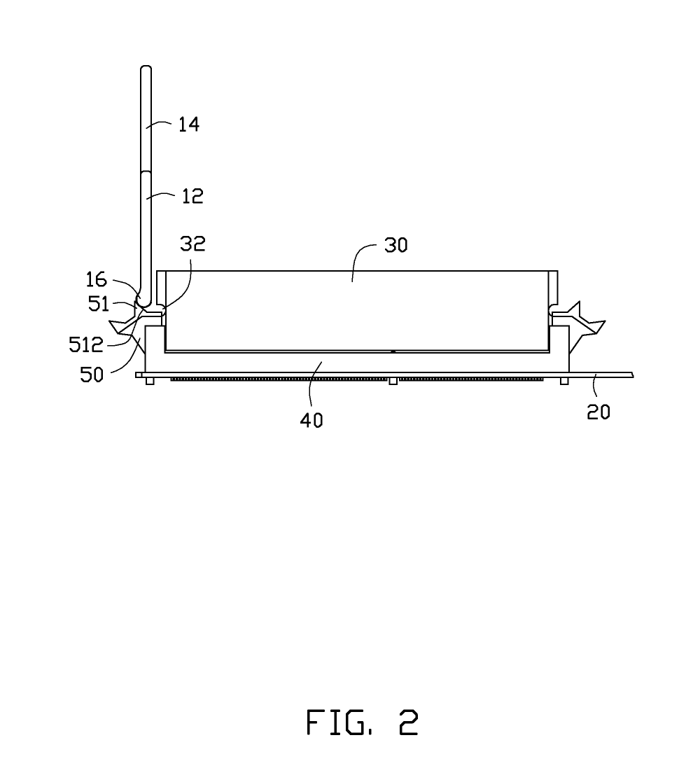

FIGS. 1 and 2 show an exemplary embodiment of a wrench 10 for a plurality of memory cards 30. The memory cards 30 are connected to a plurality of memory slots 40. The memory slots 40 are attached to a circuit board 20.

Two hooking slots 32 are defined in opposite ends of each memory card 30. Two hooks 50 are pivotably connected to first and second ends of the memory slot 40. A protrusion 51 is formed on a top of each hook 50. The protrusion 51 is spaced from the corresponding memory card 30. A slanting surface 512 is formed on an inner side of the protrusion 51 facing the memory card 30.

The wrench 10 includes a rectangular main body 12, a handle 14 extending from a middle of a first end of the main body 12, and an arced abutting portion 16 formed on a second end of the main body 12 opposite to the first end. The length of the abutting portion 16 is defined as “L”, and the total width of the memory slots 40 is defined as “W”, wherein L≧W.

To pull out the memory cards 30, the wrench 10 is placed above the circuit board 20, and is manipulated to be perpendicular to the circuit board 20. The wrench 10 is aligned with the protrusions 51 at the first ends of the memory slots 40. The wrench 10 is manipulated down, to allow the abutting portion 16 to abut the slanting surfaces 512 at the first ends of the memory slots 40. The abutting portion 16 is slid down along the slanting surfaces 512, to make the hooks 50 at the first ends of the memory slots 40 rotate outward to disengage from the memory cards 30. Using the same manner as above, the hooks 50 at the second ends of the memory slots 40 disengage from the memory cards 30. Therefore, the memory cards 30 can be pulled out from the memory slots 40.

An operator can disengage the hooks 50 from the memory cards 30 by using the wrench 10, thereby avoiding the hooks 50 from hurting fingers of the operator.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A wrench for disengaging hooks of a plurality of memory slots from a plurality of memory cards, comprising:
a main body;
a handle extending from a first end of the main body; and
an arced abutting portion formed on a second end of the main body opposite to the first end, wherein, when disengaging the hooks, the abutting portion are inserted between the hooks pivotably connected to same ends of the plurality of memory slots and the ends of the memory cards and pried, to make the hooks rotate away from the memory cards.

2. The wrench of claim 1, wherein a length of the abutting portion is not less than a total width of the plurality of memory slots.

3. The wrench of claim 1, wherein the abutting portion abuts a slanting surface formed on each hook.

4. The wrench of claim 1, wherein the main body is rectangular.

5. The wrench of claim 1, wherein the handle extends from a middle of the first end of the main body.
